(19) United States
(12) Patent Application Publication
(10) Pub. No.: US 2025/0263605 A1
(43) Pub. Date: Aug. 21, 2025

(54) METHOD OF REMOVING ASPHALTENES FROM HYDROCARBON STREAMS USING ADSORBENT MEDIA

(71) Applicant: CRYSTAPHASE PRODUCTS, INC., Houston, TX (US)

(72) Inventors: UMAKANT PRAVINCHANDRA JOSHI, Spring, TX (US); VIKASH PATEL, Spring, TX (US); AUSTIN SCHNEIDER, Humble, TX (US); JEFFREY SCOTT OLIVER, Houston, TX (US); KRISHNA K. RAO, The Woodlands, TX (US); BRADLEY GLOVER, Houston, TX (US)

(73) Assignee: CRYSTAPHASE PRODUCTS, INC., Houston, TX (US)

(21) Appl. No.: 19/059,065

(22) Filed: Feb. 20, 2025

Related U.S. Application Data
(60) Provisional application No. 63/555,558, filed on Feb. 20, 2024.

(51) Int. Cl. C10G 25/00; B01J 20/30; C10G 25/06; C10G 25/12

(52) U.S. Cl. CPC C10G 25/003; B01J 20/3007; B01J 20/3021; B01J 20/3078; C10G 25/06; C10G 25/12; C10G 2300/206

(57) ABSTRACT

An asphaltene adsorbent media, its method of preparation and a process of removing asphaltenes from hydrocarbon streams are provided. The asphaltene adsorbent media can include activated carbon (AC), metal oxide and clay as the main ingredients and be installed upstream of a processing vessel or located within processing vessels such as a fixed bed reactor. The adsorbent media can be used to remove asphaltenes contained in hydrocarbon fluids within refineries for various processing units, chemical operations, and bio-operations.

### RELATED APPLICATIONS

This application claims the benefit, and priority benefit, of U.S. Provisional Patent Application Ser. No. 63/555,558, filed Feb. 20, 2024, the disclosure and contents of which are incorporated by reference herein in their entirety.

### BACKGROUND

### 1. Field of the Invention

The presently disclosed subject matter relates to removing soluble asphaltene compounds from process streams, and in particular, from hydrocarbon streams.

### 2. Description of the Related Art

Crude oil is comprised of four main hydrocarbon organic compounds including paraffins, napthenes, aromatics, and asphaltenes. Paraffins, or alkanes, are saturated hydrocarbons that consist only of hydrogen and carbon atoms, having the general formula CₙH₂ₙ₊₂. All bonds are single bonds, and the carbon atoms are not joined in cyclic structures but instead form a simple or branched chain. They make up from about 15 to about 60% of crude oil, and on average about 30%. Resins or naphthenes, otherwise known as cycloalkanes, are alkanes that have one or more rings of carbon atoms in the chemical structure of their molecules, having the general formula CₙH₂ₙ. They make up from about 30 to about 60% of crude oil, and on average about 49%. Aromatics, or arenes, are hydrocarbons with alternating double and single bonds between carbon atoms forming rings. Aromatics make up from about 3 to about 30% of crude oil, and on average about 15%.

Asphaltenes are very complex molecules not defined by their chemical identity and are the heaviest multicomponent and most polarizable fractions of crude oil. Asphaltenes typically make up to about 10% of crude oil. However, heavy crude oils can contain much greater than 10% asphaltenes.

Various methods are known in the art to treat various feedstocks to reduce the asphaltenes content. However, these known methods either require a large volume of hydrocarbon solvents such as heptane solvent or the adsorbent is quickly saturated and with poor selectivity of asphaltenes. Moreover, none of the known methods specifically address the loading of asphaltene adsorbent within the catalyst reactor.

Improvements in this field of technology are desired.

### SUMMARY

In accordance with the presently disclosed subject matter, various illustrative embodiments of an asphaltene adsorbent media, its method of preparation and a method of removing asphaltenes from hydrocarbon streams are provided herein.

In certain illustrative embodiments, a method of removing soluble asphaltene compounds from a hydrocarbon fluid within a process vessel is provided. The hydrocarbon fluid can be passed over at least one layer of solid adsorbent media in the process vessel, wherein the solid adsorbent media is a multi-component media comprising at least one metal oxide, at least one clay, and at least one activated carbon. At least some of the soluble asphaltene compounds of the hydrocarbon fluid can be adsorbed on the solid adsorbent media. The process vessel can have at least one fixed bed therein. The solid adsorbent media can include at least one of extrudates, pellets, tablets, rings, reticulated materials and monoliths. The solid adsorbent media can include at least one of rings, trilobes, quad lobes and polyhedrons. The metal oxide, the clay and the activated carbon are not used as a support material for the at least one metal oxide.

In certain illustrative embodiments, a method of removing asphaltene from a hydrocarbon fluid containing soluble asphaltene compounds within a process vessel is provided. A solid adsorbent media can be mixed into the hydrocarbon fluid, wherein the solid adsorbent media is a multi-component media comprising at least one metal oxide, at least one clay, and at least one activated carbon. The hydrocarbon fluid containing the solid adsorbent media can be introduced into the process vessel. The hydrocarbon fluid containing the solid adsorbent media can be passed through the process vessel over a period of time. The hydrocarbon fluid containing the solid adsorbent media can then be removed from the process vessel, wherein upon removal the asphaltene content of the hydrocarbon fluid is less than when the hydrocarbon fluid was introduced into the process vessel. Additionally, the hydrocarbon fluid can be introduced into a liquid-solid separation process after the hydrocarbon fluid is removed from the process vessel. The solid adsorbent media can include at least one of extrudates, pellets, tablets, rings, reticulated materials and monoliths. The solid adsorbent media can include at least one of rings, trilobes, quad lobes and polyhedrons.

In certain illustrative embodiments, a method of generating a multi-component asphaltene adsorbent media is provided. A first powder comprising an activated carbon, a second powder comprising a metal oxide, and a third powder comprising a clay can be mixed to form a powder mixture. The powder mixture can be introduced into an aqueous acidic solution to generate a dough. Water can be removed from the dough to produce an adsorbent-base. The adsorbent-base can be calcined to produce a calcined-adsorbent-base. The calcined-adsorbent-base can be ground to produce an adsorbent powder. Additionally, the adsorbent powder can be formed or shaped into one or more of extrudates, pellets, tablets, rings, reticulated materials and monoliths. The adsorbent powder can be formed or shaped into one or more of rings, trilobes, quad lobes and polyhedrons.

In certain illustrative embodiments, a method of generating a multi-component asphaltene adsorbent media is provided. A first powder comprising an activated carbon, a second powder comprising a metal oxide, and a third powder comprising a clay can be mixed to form a powder mixture. The powder mixture can be introduced into an aqueous acidic solution to generate a dough. The dough can be shaped to produce a shaped-adsorbent media. Water can be removed from the shaped-adsorbent media to produce a dried-shaped-adsorbent media. The dried-shaped-adsorbent media can be calcined to produce a shaped-calcined-adsorbent media. Additionally, the shaped-calcined-adsorbent media can include one or more of extrudates, pellets, tablets, rings, reticulated materials and monoliths. The shaped-calcined-adsorbent media comprises one or more of rings, trilobes, quad lobes and polyhedrons.

In certain illustrative embodiments, a method of removing asphaltene from a hydrocarbon fluid containing soluble asphaltene compounds within a pre-treatment vessel is provided. The hydrocarbon fluid can be introduced into the pre-treatment vessel, wherein the pre-treatment vessel is located upstream of a process vessel. The hydrocarbon fluid can be passed over at least one layer of solid adsorbent media in the pre-treatment vessel, wherein the solid adsorbent media is a multi-component media comprising at least one metal oxide, at least one clay, and at least one activated carbon, and wherein having passed through the at least one layer of solid adsorbent media, the asphaltene content in the hydrocarbon fluid is reduced. In some aspects, the reduction can by at least 10 weight percent less (preferably 20 weight percent less, preferably 40 weight percent less, preferably 50 weight percent less, preferably 60 weight percent less, preferably 75 weight percent less, preferably 80 weight percent less, preferably 90 weight percent less, preferably 99 weight percent less) of the asphaltenes as compared to the hydrocarbon stream. The pre-treatment vessel can have at least one fixed bed therein. Additionally, the shaped-calcined-adsorbent media can include one or more of extrudates, pellets, tablets, rings, reticulated materials and monoliths. The shaped-calcined-adsorbent media comprises one or more of rings, trilobes, quad lobes and polyhedrons.

In certain illustrative embodiments, a method of removing soluble asphaltene compounds from a hydrocarbon fluid within a pre-treatment vessel is provided. The hydrocarbon fluid can be passed over at least one layer of solid adsorbent media in the pre-treatment vessel, wherein the solid adsorbent media is a multi-component media comprising at least one metal oxide, at least one clay, and at least one activated carbon, and wherein the pre-treatment vessel located upstream of a process vessel. At least 10 weight percent less (preferably 20 weight percent less, preferably 40 weight percent less, preferably 50 weight percent less, preferably 60 weight percent less, preferably 75 weight percent less, preferably 80 weight percent less, preferably 90 weight percent less, preferably 99 weight percent less) of the soluble asphaltene compounds within the hydrocarbon fluid can be adsorbed on the solid adsorbent media. The pre-treatment vessel can have at least one fixed bed therein. The solid adsorbent media can include one or more of extrudates, pellets, tablets, rings, reticulated materials and monoliths. The solid adsorbent media can include one or more of rings, trilobes, quad lobes and polyhedrons. The solid adsorbent media can adsorb the asphaltene content when the temperature of the hydrocarbon fluid is below 200° C. and above 20° C.

In certain illustrative embodiments, a method of removing soluble asphaltene compounds from a hydrocarbon fluid within a process vessel is provided. The hydrocarbon fluid can be passed over at least one layer of solid adsorbent media in the process vessel, wherein the solid adsorbent media is a multi-component media comprising magnesium oxide, at least one clay, and at least one activated carbon. At least some of the soluble asphaltene compounds within the hydrocarbon fluid can be adsorbed on the solid adsorbent media. In some aspects, the adsorption can be least 10 weight percent less (preferably 20 weight percent less, preferably 40 weight percent less, preferably 50 weight percent less, preferably 60 weight percent less, preferably 75 weight percent less, preferably 80 weight percent less, preferably 90 weight percent less, preferably 99 weight percent less) of the soluble asphaltene compounds within the hydrocarbon fluid.

### BRIEF DESCRIPTION OF DRAWINGS

A better understanding of the presently disclosed subject matter can be obtained when the following detailed description is considered in conjunction with the drawings and figures herein, wherein:

FIG. 1 is a pair of SEM images of asphaltene extracted from vacuum gas oil feedstock in accordance with an illustrative embodiment of the presently disclosed subject matter.

FIG. 2 is a bar graph showing asphaltenes adsorption at 150° C. for various materials by weight percent pickup in accordance with an illustrative embodiment of the presently disclosed subject matter.

FIG. 3 is an image of asphaltene adsorbent in ⅛″ extrudate shape in accordance with an illustrative embodiment of the presently disclosed subject matter.

FIG. 4 is a line graph showing reduction in asphaltenes vs. process temperature using a multi-component asphaltene adsorbent in accordance with an illustrative embodiment of the presently disclosed subject matter.

FIG. 5 is a front view of a continuous stirred type reactor in accordance with an illustrative embodiment of the presently disclosed subject matter.

FIG. 6 is a front view of an ebullated bed reactor in accordance with an illustrative embodiment of the presently disclosed subject matter.

FIG. 7 is a front view of a downflow fixed bed reactor (filtration+adsorbent) in accordance with an illustrative embodiment of the presently disclosed subject matter.

FIG. 8 is a front view of an upflow fixed bed reactor (adsorbent+filtration) in accordance with an illustrative embodiment of the presently disclosed subject matter.

FIG. 9 is a front view of a fixed bed reactor (filtration+catalyst/adsorbent) in accordance with an illustrative embodiment of the presently disclosed subject matter.

FIG. 10 is a front view of a fixed bed reactor (filtration+catalyst+adsorbents+catalyst) in accordance with an illustrative embodiment of the presently disclosed subject matter.

FIG. 11 is a front view of a fixed bed reactor (down flow reactor) in accordance with an illustrative embodiment of the presently disclosed subject matter.

While the presently disclosed subject matter will be described in connection with the preferred embodiment, it will be understood that it is not intended to limit the presently disclosed subject matter to that embodiment. On the contrary, it is intended to cover all alternatives, modifications, and equivalents, as may be included within the spirit and the scope of the presently disclosed subject matter as defined by the appended claims.

### DETAILED DESCRIPTION

The presently disclosed subject matter relates to an asphaltene adsorbent media, its method of preparation and method of removing asphaltenes from hydrocarbon streams. The multi-component asphaltene adsorbent media for asphaltene removal from hydrocarbon fluids outperforms currently available commercial mitigations.

Asphaltenes are typically defined by their solubility characteristics measured in the laboratory. The solubility characteristics of asphaltenes are defined to be the toluene (C₆H₅CH₃)-soluble and n-heptane (C₇H₁₆)-insoluble components of crude oil and other carbonaceous materials such as bitumen and coal and are the sticky, black, highly viscous residue of distillation processes. Asphaltenes consist primarily of certain different heteroatoms such as oxygen, nitrogen, sulfur and trace metals like vanadium, nickel, and iron. These heavy aromatic molecules can be described as having complex aromatic cores with aliphatic chains. Each heteroatom is associated with groups such as ethers, carbonyls, sulfonyls, etc. They exist not only in crude oil but also in hydrocarbon streams from the processing units of a refinery while crude is being converted to various end use products. Often this is due to the ability of asphaltenes to flocculate which is the tendency to form, or aggregate, in clumps. Asphaltene flocculation can occur in refinery processes when asphaltene solubility is impacted due to fluctuations in temperature and pressure, and compositional changes in the hydrocarbon stream. This can result in deposition of asphaltenes during refinery processing.

Asphaltenes are typically concentrated in heavier crude oils and can be problematic fractions for efficient processing. Although there is no solution yet to remove 100% of the asphaltenes in a hydrocarbone stream, adsorption, filtration and solvent extraction processes have been developed to reduce the amount of asphaltenes in order to extend continuity of processing before causing refinery operations to shut down. The C:H ratio is approximately 1:1.2, depending on the asphaltene source, and its typical concentration ranges from 50 ppmw to 200,000 ppmw or even more in a typical hydrocarbon stream within refinery processing. Asphaltenes are vast polyaromatic compounds, with molecular weight ranging from 1,000 g/mol to about 20,000 g/mol and generally possess a boiling point above 1,000 deg F.

A heavy crude having a specific gravity greater than one typically contains asphaltenes from about 3% to about 20%. There are currently a few processes to reduce asphaltenes from a hydrocarbon stream. These processes are solvent extraction and thermal cracking units. In the United State, the coker is an example of a thermal cracking unit.

Solvent extraction also known as solvent deasphalting process (SDA) is based on liquid-liquid extraction by using paraffinic solvents (C4-C7). SDA is one of the most efficient approaches to reduce metals and asphaltenes contents of heavy crude. However, the deasphalted oil product has asphaltenes content typically anywhere from about 500 to about 5,000 ppmw remaining. Even with this low level of asphaltenes, the hydrocarbon stream is considered to have a high asphaltenes content for most hydroprocessing and hydrocracking units.

Thermal cracking processes, such as coking and delayed coking are those in which hydrocarbons present in crude oil are cracked at high temperature to break the molecular bonds and break long-chained, higher-boiling hydrocarbons into shorter-chained hydrocarbons. The heavier fractions such as asphaltenes and resins are then converted to coke products. Though sometimes during the ramp up or ramp down of the unit, the light distillates from these units can contain some asphaltenes which can be problematic for downstream hydroprocessing units.

The deasphalted oil, coker distillates, atmospheric crude distillation bottom and vacuum distillation bottom can contain asphaltene ranges typically from about 300 to about 30,000 ppmw. The majority of hydroprocessing and hydrocracking units accept feed up to about 300 ppmw of asphaltenes. If high asphaltene content feed typically greater than about 350 ppmw is processed, then the catalysts in hydroprocessing units suffer deactivation, coke build up, and pressure build within the reactor resulting in early shut down.

Steam cracking, also referred to as pyrolysis, has long been used to crack various hydrocarbon feeds into olefins. The pyrolysis furnace has two main sections: a convection section and a radiant section. The hydrocarbon feed enters the convection section either already a vapor or as a liquid which is vaporized through direct contact with steam and indirect contact with burners in the radiant section. The vaporized feed then proceeds to the radiant section where cracking takes place. If non-volatile asphaltenes or other contaminants are present in the feed, coking can occur, and coking often results in costly shutdowns for cleaning.

Asphaltenes also deactivate the reactor catalysts. In refinery processes catalysts are used to remove the heteroatoms such as sulfur, nitrogen, oxygen, and metals in hydroprocessing reactors. Some of these catalysts do not react with asphaltenes; rather these heavier molecules of asphaltenes can blind the active pores of catalysts, making them unavailable for chemical reactions. If asphaltenes typically greater than about 350 ppmw in feed enter in the reactor over an extended period, the reactor will be obstructed with asphaltene deposits requiring unit shutdown for catalyst replacement.

In certain illustrative embodiments, the presently disclosed asphaltene adsorbent media can include activated carbon (AC), metal oxide and clay and can be installed upstream of a processing vessel or located within processing vessels such as a fixed bed reactor. The adsorbent media can be used to remove asphaltenes contained in hydrocarbon fluids within refineries for various processing units, chemical operations, and bio-operations.

In certain illustrative embodiments, the presently disclosed subject matter relates to optimized reactor performance by adsorbing the asphaltenes on adsorbent. This results in the processing reactor having a higher tolerance to asphaltenes, improving cycle length by reducing deposition rates on the catalyst, reduced coke formation in catalyst beds, and overall profitable cycle run for refinery/chemical operators. The present inventors have discovered an adsorbent which removes the asphaltenes very efficiently, demonstrates high selectivity for asphaltene, and exhibits high capacity to extend cycle run length.

In certain illustrative embodiments, the presently disclosed subject matter relates to an adsorbent composition, and a method of making and processing to remove asphaltenes from a hydrocarbon stream comprising; contacting the hydrocarbon stream with an adsorbent to adsorb the asphaltenes from the hydrocarbon stream to produce an asphaltene depleted hydrocarbon stream which has at least 10% by weight less than the asphaltenes as compared to the hydrocarbon stream. The adsorbent has a total surface area of about 100 to about 1200 m²/gram, a pore volume of about 0.04 to about 1.01 cc/gram, and a pore diameter of about 3 to about 20 nm.

In certain illustrative embodiments, the presently disclosed subject matter relates to carrying out the adsorption at temp ranges from about 20° C. to about 400° C., and preferably the temp ranges from about 150° C. to about 400° C., and residence time ranges from about 1 minute to about 12 hours depending on the asphaltene content level present in the hydrocarbons streams that flow out from different processing vessels to achieve the optimum efficiency of adsorbent.

In certain illustrative embodiments, the presently disclosed subject matter also relates to a multi-component media for asphaltene adsorbent. About 20 to about 60% activated carbon, about 10 to about 40% magnesium oxide and about 5 to about 25% clay are required to make an effective adsorbent to adsorb the asphaltenes.

Asphaltene stability in the hydrocarbon stream depends on both the paraffinicity of the hydrocarbon fluid as well as the temperature and pressure of the fluid. The more paraffinic the fluid, the more likely asphaltenes are to destabilize and form solids. The lower the temperature of the hydrocarbon fluid the more likely asphaltenes are to destabilize and form solids. The temperature stability of asphaltenes can exhibit significant hysteresis in asphaltene solubility vs temperature. This is particularly challenging in multi-bed systems where temperatures can be elevated at the effluent of an upstream bed, whereby the exiting hydrocarbon stream can then be subject to quenching. Upon quenching, the temperature of the hydrocarbon stream can drop and destabilize asphaltenes, generating solids post-quenching and fouling the bed. Due to the hysteresis in asphaltene stability, destabilized asphaltenes cannot typically dissolve back into the hydrocarbon fluid. Similarly, changes in pressure, especially lower pressures, tend to destabilize asphaltenes and cause them to drop out of the hydrocarbon stream.

Additionally, the paraffinic dependence of the solubility can demonstrate similar issues where fresh or recycled hydrocarbon feed is also introduced into the process at lower beds, creating a threat for asphaltene destabilization at those mixing zones.

In certain illustrative embodiments, the presently disclosed subject matter is intended to adsorb and remove asphaltenes from the hydrocarbon stream prior to these destabilizing conditions. The presently disclosed subject matter can be used for cases such as upgrading heavier hydrocarbon streams such as atmospheric bottom, vacuum residues, FCC charge feedstocks, cat feed hydrotreater, and hydrocracker feeds, etc.

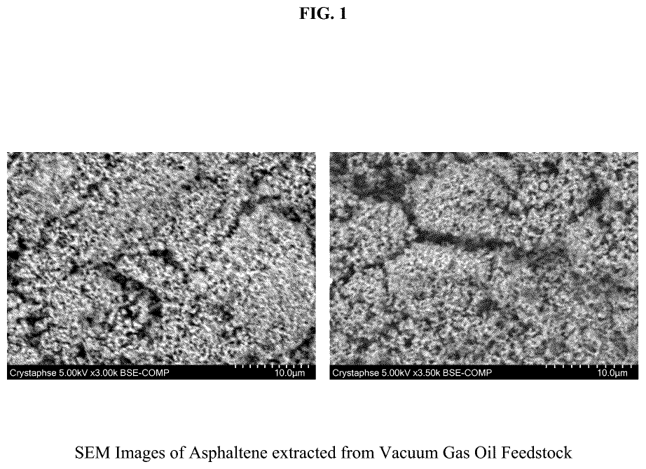

FIG. 1 depicts SEM (Scanning Electron Microscope) images of asphaltenes extracted from Vacuum Gas Oil bottom residues.

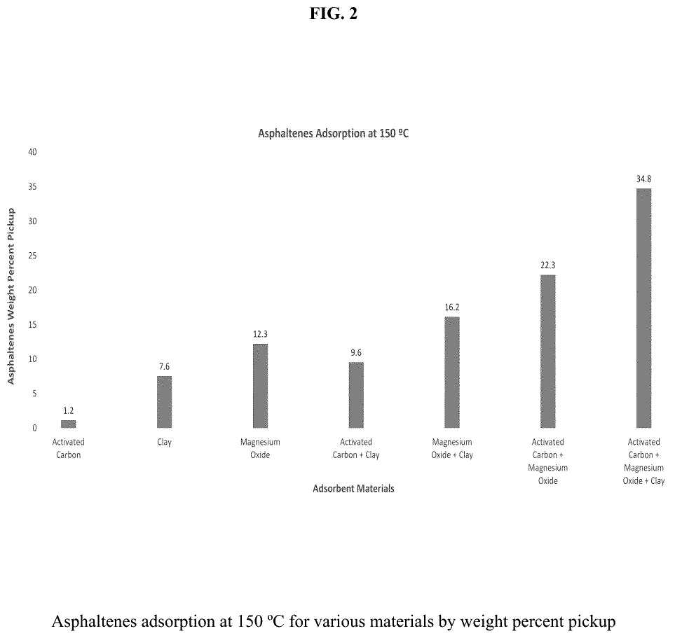

FIG. 2 shows the asphaltenes adsorption capability of various materials at 150° C. The chart illustrates the results of each of the three single medias when independently evaluated for asphaltene absorption. The materials have limited capabilities with magnesium oxide exhibiting the most absorption at about 12 weight percent pickup. Next, the chart illustrates the results of dual media combinations of the constituent materials having marginally improved asphaltene adsorption. The combination of activated carbon and clay exhibited about 9% more asphaltene weight pickup compared to the sum of the independent constituents. The combination of magnesium oxide and clay exhibited about 20% more asphaltene weight pickup compared to the sum of the independent constituents. The combination of activated carbon and magnesium oxide exhibited about 12% more asphaltene weight pickup compared to the sum of the independent constituents. Finally, the chart illustrates the result of the multi-component media of activated carbon, magnesium oxide and clay having a much greater than expected asphaltene adsorbtion when compared to any single constituent media and compared to any dual constituent media. The multi-component media exhibited about 70% more asphaltene weight pickup compared to the sum of the independent constituents. As shown, the multi-component media of activated carbon, magnesium oxide and clay performs better than single and double components for asphaltene adsorption from a hydrocarbon fluid.

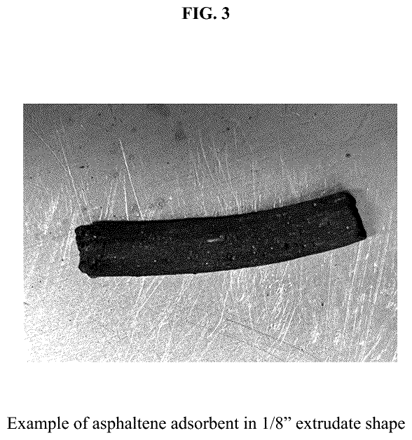

FIG. 3 depicts an example of a ⅛″ extrudate made from the invented asphaltene adsorbent and its real density and porosity. The depicted asphaltene extrudate example has a real density of 2.15 g/cc, a porosity of 77.47%, a surface area of 938.35 m²/gram, and a pore diameter of 6.99 nanometers. The typical expected real density range of such an extrudate is about 2.05 to about 2.25 g/cc. The typical expected range of porosity of such an extrudate is about 60 to about 80 volume percent. The typical expected range of surface area of such as extrudate is about 700 to about 1000 m²/gram. The typical expected range of pore diameter of such an extrudate is about 3 to about 20 nm.

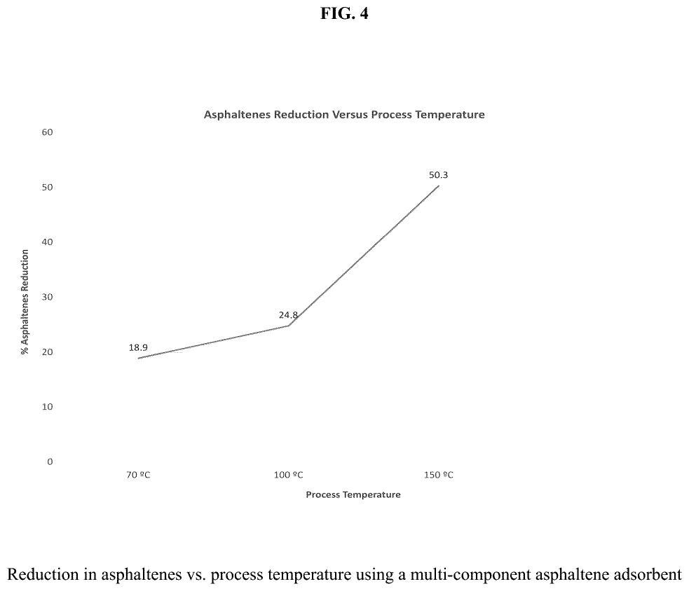

FIG. 4 depicts the reduction in asphaltenes using the multi-component adsorbent as a function of process temperature.

In certain illustrative embodiments, the asphaltene adsorption can be carried out by employing a carbon-based formula: carbon+metal oxide+clay. Various clays can be used. The preferred composition is activated carbon+magnesium oxide+bentonite clay. This formula has been shown to have the highest selectivity for asphaltene adsorption as well as the largest capacity in terms of asphaltene pickup per gram of adsorbent.

Metal oxides can include without limitation one or more oxides containing metal, such as basic oxides, transition metal or amphoteric oxides, and compound metal oxides. Suitable metal oxides include titanium dioxide, zirconium oxide, magnesium oxide, nickel oxide, or cobalt oxide, molybdenum oxide. Suitable metal oxides can include microscale or nanoscale particle sizes.

Clays can include without limitation one or more phyllosilicate clays such as smectite clays, kaolinite type clays, illite sepiolite, palygorskite (attapulgite) clays or clays comprising of such mixtures.

Carbon can include without limitation one or more sources of activated carbon, inactivated carbon, carbon black, or mixtures thereof. Suitable carbons include activated carbon made from hardwood, coconut shell, biomass wastes such as agriculture residues, or plastic pyrolysis carbon chars.

In certain illustrative embodiments, the presently disclosed subject matter relates to the making of the formulation of the multi-component asphaltene adsorbent. In an illustrative embodiment, the asphaltene adsorbent can be comprised of activated carbon in the amount of about 51%, magnesium oxide in the amount of about 27%, bentonite clay in the amount of about 19%, and water with phosphoric acid in the amount of about 3%, which is used as a wetting agent. In another illustrative embodiment, the asphaltene adsorbent can be comprised of activated carbon in the typical range of about 20 to about 60%, magnesium oxide in the typical range of about 10 to about 40%, clay in the typical range of about 5 to about 30%, and water with phosphoric acid in the typical range of about 1 to about 10%. In another illustrative embodiment, the asphaltene adsorbent can be comprised of activated carbon in the typical range of about 40 to about 60%, magnesium oxide in the typical range of about 20 to about 35%, clay in the typical range of about 15 to about 25%, and water with or without phosphoric acid in the typical range of about 1 to about 10%.

In certain illustrative embodiments, the presently disclosed subject matter relates to a process for removing asphaltene from hydrocarbon streams (such as crude petroleum streams, intermediate process streams like bottoms of atmospheric and vacuum distillations, FCC charge feedstocks, heavy residual streams) comprising: contacting the hydrocarbon stream with an invented adsorbent to adsorb the asphaltenes from the hydrocarbon stream to produce an asphaltene depleted hydrocarbon stream with at least 10 weight percent less (preferably 20 weight percent less, preferably 40 weight percent less, preferably 60 weight percent less, preferably 80 weight percent less, preferably 99 weight percent less) of the asphaltenes as compared to the hydrocarbon stream.

In certain illustrative embodiments, the presently disclosed subject matter relates to an asphaltene adsorbent having a composition as set forth in the previous paragraph and surface properties where the typical surface area is about 900 m²/gram, the typical pore volume is about 0.55 cc/gram, and the typical pore diameter is about 5 nanometers. Respective ranges for these values could typically be about 700 to about 1000 m²/gram, about 0.4 to about 0.8 cc/gram, and about 3 to about 15 nm.

Table 1 shows the select properties of various adsorbent materials.

TABLE 1

| | Surface | Pore | Pore |
|---|---|---|---|
| | Area | Volume | Diameter |
| Adsorbent Material Name | (m²/g) | (cm³/g) | (Nm) |
| Activated Carbon powder | 1660.84 | 1.01 | 5.19 |
| (hardwood derived) | | | |
| Activated Carbon powder | 1530.24 | 0.85 | 4.11 |
| (coconut shell derived) | | | |
| Activated Carbon extrudate | 1083.43 | 0.04 | 3.94 |
| Activated Carbon extrudate | 1556 | 0.87 | 6.53 |
| (made from AC powder - | | | |
| hardwood derived) | | | |
| Bentonite clay | 142.31 | 0.14 | 4.88 |
| TiO₂ | 350/200 | 0.8 | 9 |
| ZrO₂ | 13.57 | 0.06 | 20.03 |
| MgO | 8.87 | 0.04 | 16.1 |
| AC + TiO₂ + ZrO₂ | 475.78 | 0.45 | 6.54 |
| AC + ZrO + Clay | 831.05 | 0.56 | 7.19 |
| AC + MgO + Clay | 938.35 | 0.6 | 6.99 |

In certain illustrative embodiments, through the combination of a metal oxide, a clay, and a carbon to create an integral multi-component media, the key parameters of surface area, pore size, and pore volume are optimized to achieve greater adsorption capability and cation exchange capability than the constituent components or the summation of the constituent components.

In certain illustrative embodiments, the presently disclosed subject matter relates to an addition of magnesium oxide (MgO) to the active ingredient of activated carbon and the adsorbent constituent clay to improve the selectivity of asphaltenes adsorption and so to increase the capacity of the adsorbent resulting in the capacity to adsorb more asphaltenes per unit weight of adsorbent. In another embodiment, titanium dioxide (TiO₂) and zirconium dioxide (ZrO₂) could be substituted for the MgO in similar quantities. In another embodiment, amphoteric oxides could be substituted for the MgO in similar quantities. Amphoteric oxides can include aluminum oxide, zinc oxide, lead oxide, tin oxide, beryllium oxide, chromium oxide, vanadium oxide, iron oxide, cobalt oxide, copper oxide, gallium oxide, iridium oxide scandium oxide, germanium oxide, antimony oxide, bismuth oxide, osmium oxide, manganese oxide, or others.

In certain illustrative embodiments, each of the component materials can be combined to create the multi-component adsorbent media without the requirement for a substrate. In particular, the significant addition of clay as an adsorbent constituent beyond the typical binder level of up to 2% leads to greater and improved adsorption capability.

### Asphaltenes

Asphaltenes are material derived from petroleum or natural gas (such as crude or refined petroleum streams) that are insoluble in n-heptane and n-pentane as determined by ASTM D-6560.

In a preferred embodiment, the asphaltenes treated herein are insoluble in n-heptane and n-pentane and are soluble in toluene.

In certain illustrative embodiments, a method of treatment in a process vessel is provided that includes providing an adsorption zone in the process vessel wherein the adsorption zone contains a plurality of asphaltene absorbent media; passing a fluid stream with entrained asphaltenes through the adsorption zone and removing a portion of the asphaltenes from the fluid stream with the asphaltene absorbent media wherein the fluid stream contains some asphaltenes. In another embodiment, the fluid stream would typically contain greater than about 300 ppmw asphaltenes. In another embodiment, the fluid stream would typically contain about 300 to about 30,000 ppmw asphaltenes. In another embodiment, the fluid stream would typically contain about 5,000 to about 20,000 ppmw asphaltenes. In another embodiment, the fluid stream would typically contain about 300 to about 2,000 ppmw asphaltenes.

### Hydrocarbon Streams

Suitable hydrocarbon streams containing asphaltenes for use in the presently disclosed subject matter include naphtha boiling range materials, heavier than naphtha such as heavy condensates, gas oils, kerosene, hydrocrackates, crude oils, and/or crude oil fractions. Examples of hydrocarbon streams are natural gas condensates, low sulfur waxy residue, crude, vacuum resid, hydrotreated atmospheric resid, hydrotreated vacuum resid, and hydrotreated crude.

In certain illustrative embodiments, asphaltene-rich hydrocarbon streams treated by the presently disclosed subject matter contain at least 1 ppmw, preferably about 300 ppmw to about 500 ppmw, preferably about 300 to about 30,000 ppmw, more preferably about 5,000 to about 20,000 ppmw, more preferably about 300 to about 2,000 ppmw as n-heptane insoluble.

In certain illustrative embodiments, the hydrocarbon stream is selected from gasoline, condensates, naphtha, gas oil, and resid where adsorbing conditions comprise a temperature ranging from about 20° C. to about 400° C.

In certain illustrative embodiments, the asphaltene-rich hydrocarbon stream is selected from the group consisting of condensates, gas oil, naphtha, distillate, and resid.

In certain illustrative embodiments, the asphaltene-rich hydrocarbon stream comprises heavy atmospheric gas oil, virgin gas oil, FCC charge feedstock, atmospheric and vacuum distillation bottoms, and resid.

### Adsorption Process Parameters for Testing

In certain illustrative embodiments, the asphaltene adsorbing condition comprises a temperature ranging from about 20° C. to about 400° C., LHSV (liquid hourly space velocity, 1/hr) ranging from about 1 to about 75 hr-1, and a pressure ranging from about 1 bar to about 150 bar. In another embodiment of this aspect of the presently disclosed subject matter, the asphaltene adsorbing condition comprises a temperature ranging from about 20° C. to about 400° C., LHSV (liquid hourly space velocity, 1/hr) ranging from about 0.5 to about 100 hr-1, and a pressure ranging from about 1 bar to about 150 bar.

In certain illustrative embodiments, the process comprises using adsorption temperatures from about 150° C. to about 400° C. In another embodiment, the process comprises using adsorption temperatures from about 70° C. to about 400° C.

In certain illustrative embodiments, the adsorption capacity increased by using the invented asphaltene adsorbent having the composition of activated carbon, magnesium oxide, and bentonite clay as main ingredients and water with phosphoric acid as a wetting agent. Additionally, the adsorbent has a typical surface area of about 900 m²/gram, a typical pore volume of about 0.55 cc/gram, and a typical pore diameter of about 5 nanometers.

In certain illustrative embodiments, the asphaltene depleted hydrocarbon stream contains 10% less asphaltene by weight than it was originally in the hydrocarbon feed, preferably 20%, preferably 40%, preferably 50%, preferably 60%, preferably 75%, preferably 80%, preferably 90%, and preferably 99% less asphaltenes in the hydrocarbon stream.

In certain illustrative embodiments, the asphaltenes in the hydrocarbon stream were reduced by the invented asphaltene adsorbent as evidenced by at least 10% weight pickup on the absorbent, preferably at least 20%, preferably at least 40%, preferably at least 50%, preferably at least 60%, preferably at least 75%, preferably at least 80%, preferably at least 90%, and preferably at least 99% weight pickup on the adsorbent.

Adsorption Vessels: Stand-Alone Vessel and/or within Catalyst Beds in Processing Reactor

In certain illustrative embodiments, the hydrocarbon stream containing asphaltenes is in contact with an adsorption zone with the adsorbent media capable of adsorbing asphaltenes from the feed. The adsorption zone typically comprises one or more vessels of sufficient volume to allow adequate contact for the feed to be treated by the adsorbent media. The vessel may contain a suitable thermocouple within the vessel to check the temperature rise due to asphaltene adsorption. Additionally, the vessel may contain sampling points to collect the samples and analyze same for adsorption of asphaltenes. Based on both the efficiency and the capacity of adsorbent media, asphaltene adsorption is conducted continuously for a fixed tenure such as a few days to a few years. Once the adsorbent media is saturated with asphaltenes, the vessel will be emptied and loaded again with the fresh adsorbent media for the next cycle.

The adsorbent media may be installed in the adsorption zone in any suitable manner. The vessel can be configured as a fixed bed, ebullating bed or slurry bed. All these beds are well known in the art. The adsorbent may be installed in one or more vessels and in either series or parallel flow.

In certain illustrative embodiments, the flow of the hydrocarbons through the adsorption zone may be conducted in an upflow, downflow or radial flow manner. The temperature and pressure of the adsorption zone are preferably selected to maintain the hydrocarbons in the liquid state. After contacting the hydrocarbon with the adsorbent, the effluent is upgraded to a stream with lowered asphaltene content.

In certain illustrative embodiments, the method can include regenerating the solid asphaltene adsorbent when the asphaltene depleted hydrocarbon stream contains more than allowable asphaltene (preferably about 50 ppmw or less than about 100 ppmw) in the hydrocarbon stream entering the process, which is effluent of adsorption vessel. Additionally, the regeneration of solid adsorbent is achieved with aromatic solvents such as toluene, toluene-methanol or any such liquid capable of removing asphaltene from the adsorbent.

In certain illustrative embodiments, the solid asphaltene adsorbent in extrudate shape (preferably ⅛″, 3/16″, ¼″ diameter and ¼″ to ¾″ in length) need to be removed. The volume of adsorbent can be calculated based on asphaltene removal needed from the hydrocarbon feed entering the reactor. In a petroleum refinery, the processing reactors such as a hydrotreater, a hydrocracker, a cat feed hydrotreater, etc., where the asphaltene in the feed range from about 500 ppmw to about 2,000 ppmw become highly detrimental to catalyst activity as well as responsible for coke formation within the catalyst bed in the reactor. In those cases, the invented solid asphaltene adsorbent installed in the top bed can inhibit and ultimately prevent the catalysts from deactivation. In other embodiments, the diameter of the extruded adsorbent varies from inches to as low as 1/32″.

In certain illustrative embodiments, the invented solid asphaltene adsorbent are non-reactive to hydrocarbons and only adsorb the asphaltenes and its associated metals.

### Asphaltenes Adsorbent Media

Porosity is determined by first measuring the real density of asphaltene adsorbent's extrudate with the Helium Pycnometer. From this total volume measured by the He Pycnometer, the pore volume is calculated. The Porosity=(volume of void/total volume)×100.

Asphaltene adsorption is determined by weight (grams) of asphaltenes adsorbed by the total weight (grams) of adsorbent extrudates taken in a small reactor.

ASTM D6560 is used to determine the asphaltenes in feed and in effluent of reactors. In this method 1 gram of oil samples is dissolved in 40 grams of n-heptane and agitated for half an hour. All the asphaltenes are precipitated and the filtered with 0.45-micron filter. This filter is dried for an hour until the n-heptane solvent is dried. The weight of asphaltenes deposited on the filter is weighed by taking the weight difference of the filter before and after of test. By this way, the asphaltenes in the feed as well as in the reactor effluent are measured until the adsorbent is saturated and the effluent asphaltene level is less than the allowable limit, which is typically less than about 500 ppm asphaltenes.

In certain illustrative embodiments, the adsorbent for the presently disclosed subject matter are those adsorbents capable of selectively adsorbing asphaltenes. Such adsorbents have the main ingredients: Activated Carbon, Magnesium Oxide, and Bentonite Clay. The extrudate is made by adding the required volume of wetting agent consisting of water with some amount of phosphoric acid to bring the water pH level to approximately 5. In another embodiment the water pH level can be in the range of 1 to up to 7.

In certain illustrative embodiments, the activated carbon is selected from a group consisting of activated carbon made from coconut shell, biomass, coal, coke, and graphitized carbon.

In certain illustrative embodiments, magnesium oxide is added to improve the selectivity of asphaltenes adsorption.

In certain illustrative embodiments, the presently disclosed subject matter relates to the method of making the adsorbent extrudate with a minimum 75% porosity. Porosity could also be greater than 20%, greater than 30%, greater than 40%, greater than 50%, or greater than 60%.

The presently disclosed subject matter is further illustrated by the following Examples which are provided for the purpose of representation and are not to be construed as limiting the scope of the presently disclosed subject matter. Unless stated otherwise, all percentages, parts, etc., are by weight.

### Clays

There are 30 different types of clays, but most deposits are mixtures of clays. The defining mechanical property of clay is the plasticity when wet and its ability to harden when fired. Clays contain a high degree of minerals that contribute to its plasticity. At high water content, they behave like plastics and at lower concentration, they exhibit plasticity. Clay minerals are anhydrous aluminum poly-silicate minerals composed of alumina and silica bonded into tiny thin plates by interconnecting the oxygen and hydroxide ions. The major clay types that have high mineral contents are smectites. kaolinites, vermiculites, sepiolite's and pyrophyllites.

Clays are currently used in paper making, cement production, chemical filtration, and a mold binder in the manufacturing of sand castings. Amongst these, bentonite clay, which is a smectite clay, is extensively used as a binder as the plasticity aids mixing with other components such as cement, gravel, and alumina by lowering viscosity and thereby reducing the drag coefficient. Clays are currently used as an adsorbent to remove other contaminants in other industries.

To define suitable clays for absorption or adsorption of organic, inorganic, and metal contaminants from the various streams, it is important to consider clays with large surface area including smectite clays (dioctahedral and trioctahedral smectite clays). In one illustrative embodiment, the asphaltene adsorbent media contains smectite clay with a surface area in the range of 40-1,000 square meters/gram. In another illustrative embodiment, the asphaltene adsorbent media contains allophane clay with a surface area of 1,800-2,600 square meters/gram. In another illustrative embodiment, the asphaltene adsorbent media contains imogolite clay with a surface area of 1,100-2,000 square meters/gram. In another illustrative embodiment, the asphaltene adsorbent media contains vermiculite clay with a surface area of 360-1,160 square meters/gram.

### Asphaltene Removal Examples

### Example 1

### Activated Carbon (AC)

Activated carbon extrudates were used for testing as the adsorbent media. 100 grams of the adsorbent media were placed in a small, fixed bed reactor of 150 ml with 80 ml of hydrocarbon fluid poured into the reactor. The hydrocarbon fluid is a mix of heavier fractions of hydrocarbon fluids in a refinery, composed of bottom of atmospheric column, bottom of vacuum column, coker heavies, etc. The temperature was raised to 150° C. The asphaltenes in the feed and the asphaltenes after 1 hour residence time with the adsorbent media were analyzed per ASTM D6560 heptane insoluble method. The oil sample was mixed with heptane, agitated for 30 minutes and precipitants filtered on 0.45-micron filter paper. The weight difference of precipitated asphaltenes minus the weight of the filter paper was the asphaltene weight pickup. This was divided by the starting extrudate weight to determine the asphaltenes removed per unit weight of absorbent or say weight percent picked up by the adsorbent media. It was observed that 1.22 weight percent of asphaltenes was picked up by the adsorbent media. This process was repeated using subsequent 80 ml batches of oil and the same extrudates until there was no further weight pickup. When no further weight pickup was observed, the adsorbent media was saturated.

A summary of the experiment is as follows:
Weight of activated carbon extrudates: 100 grams
Samples of oil in grams in each batch: 72.87 grams
Temperature of adsorption test: 150° C.
Residence time: 1 hour
Oil processed until extrudates saturated: 302 grams (332 ml)
Asphaltenes pick up weight percent: 1.22%
Adsorbent's saturation capacity-grams of feed/gram of adsorbent: 3.2

### Example 2

### Magnesium Oxide (MgO)

Magnesium oxide extrudates made from magnesium hydroxide were used for testing as the adsorbent media. Magnesium hydroxide was heated to 232° C. to remove the hydroxyl group. The adsorbent media was made with a lab extruder. Water and binder were used to make the MgO paste for extrusion. The adsorbent media was dried. 100 grams of the adsorbent media were placed in a small, fixed bed reactor of 150 ml with 80 ml of hydrocarbon fluid poured into the reactor. The hydrocarbon fluid is a mix of heavier fractions of hydrocarbon fluids in a refinery, composed of bottom of atmospheric column, bottom of vacuum column, coker heavies, etc. The temperature was raised to 150° C. The asphaltenes in the feed and the asphaltenes after 1 hour residence time with the adsorbent media were analyzed per ASTM D6560 heptane insoluble method. The oil sample was mixed with heptane, agitated for 30 minutes and precipitants filtered on 0.45-micron filter paper. The weight difference of precipitated asphaltenes minus the weight of the filter paper was the asphaltene weight pickup. This was divided by the starting adsorbent media weight to determine the asphaltenes removed per unit weight of absorbent media or say weight percent picked up by the adsorbent media. This process was repeated using subsequent 80 ml batches of oil and the same adsorbent media until there was no further weight pickup. When no further weight pickup was observed, the adsorbent media was saturated. It was observed that 12.29 weight percent of asphaltenes was picked up by the adsorbent media.

A summary of the experiment is as follows:
Weight of magnesium oxide extrudates: 100 grams
Samples of oil in grams in each batch: 72.87 grams
Temperature of adsorption test: 150° C.
Residence time: 1 hour
Oil processed until extrudates saturated: 1320 grams (1450 ml)
Asphaltenes pick up weight percent: 12.29%
Adsorbent's saturation capacity-grams of feed/gram of adsorbent: 13.2

### Example 3

### Bentonite Clay

Bentonite clay extrudates made from bentonite clay powder were used for testing as the adsorbent media. The adsorbent media was made with a lab extruder. Water and binder were used to make the bentonite clay paste for extrusion. The adsorbent media was dried. 100 grams of the adsorbent media were placed in a small, fixed bed reactor of 150 ml with 80 ml of hydrocarbon fluid poured into the reactor. The hydrocarbon fluid is a mix of heavier fractions of hydrocarbon fluids in a refinery, composed of bottom of atmospheric column, bottom of vacuum column, coker heavies, etc. The temperature was raised to 150° C. The asphaltenes in the feed and the asphaltenes after 1 hour residence time with the adsorbent media were analyzed per ASTM D6560 heptane insoluble method. The oil sample was mixed with heptane, agitated for 30 minutes and precipitants filtered on 0.45-micron filter paper. The weight difference of precipitated asphaltenes minus the weight of the filter paper was the asphaltene weight pickup. This was divided by the starting adsorbent media weight to determine the asphaltenes removed per unit weight of absorbent media or say weight percent picked up by the adsorbent media. This process was repeated using subsequent 80 ml batches of oil and the same adsorbent media until there was no further weight pickup. When no further weight pickup was observed, the adsorbent media was saturated. It was observed that 7.57 weight percent of asphaltenes was picked up by the adsorbent media. This weight pick up is when the adsorbents saturated after repeating couple of 80 ml batches with same extrudate.

A summary of the experiment is as follows:
Weight of Bentonite clay extrudates: 100 grams
Samples of oil in grams in each batch: 72.87 grams
Temperature of adsorption test: 150° C.
Residence time: 1 hour
Oil processed until extrudates saturated: 805 grams (885 ml)
Asphaltenes pick up weight percent: 7.57%
Adsorbent's saturation capacity-grams of feed/gram of adsorbent: 8.5

### Example 4

### Activated Carbon (AC)+Magnesium Oxide (MgO)

Activated carbon+magnesium oxide extrudates made from mixing activated carbon powder with magnesium oxide were used for testing as the adsorbent media. The composition mixture was 60 to 70% by weight activated carbon and 30 to 40% by weight magnesium oxide. The adsorbent media was made with a lab extruder. Water and binder were used to make the AC+MgO paste for extrusion. The adsorbent media was dried. 100 grams of the adsorbent media were placed in a small, fixed bed reactor of 150 ml with 80 ml of hydrocarbon fluid poured into the reactor. The hydrocarbon fluid is a mix of heavier fractions of hydrocarbon fluids in a refinery, composed of bottom of atmospheric column, bottom of vacuum column, coker heavies, etc. The temperature was raised to 150° C. The asphaltenes in the feed and the asphaltenes after 1 hour residence time with the adsorbent media were analyzed per ASTM D6560 heptane insoluble method. The oil sample was mixed with heptane, agitated for 30 minutes and precipitants filtered on 0.45-micron filter paper. The weight difference of precipitated asphaltenes minus the weight of the filter paper was the asphaltene weight pickup. This was divided by the starting adsorbent media weight to determine the asphaltenes removed per unit weight of absorbent media or say weight percent picked up by the adsorbent media. This process was repeated using subsequent 80 ml batches of oil and the same adsorbent media until there was no further weight pickup. When no further weight pickup was observed, the adsorbent media was saturated. It was observed that 22.28% of asphaltenes was picked up by the adsorbent media.

A summary of the experiment is as follows:
Weight of AC+MgO extrudates: 100 grams
Samples of oil in grams in each batch: 72.87 grams
Temperature of adsorption test: 150° C.
Residence time: 1 hour
Oil processed until extrudates saturated: 6935 grams (7620 ml)
Asphaltenes pick up weight percent: 22.28%
Adsorbent's saturation capacity-grams of feed/gram of adsorbent: 69.35

### Example 5

### Activated Carbon (AC)+Bentonite Clay

Activated carbon+Bentonite clay extrudates made by mixing activated carbon powder and Bentonite clay powder were used for testing as the adsorbent media. The composition mixture was 70 to 80% by weight activated carbon and 20 to 30% by weight Bentonite clay. The adsorbent media was made with a lab extruder. Water and a binder were used to make the AC+Bentonite clay paste for extrusion. The adsorbent media was dried. 100 grams of the adsorbent media were placed in a small, fixed bed reactor of 150 ml with 80 ml of hydrocarbon fluid poured into the reactor. The hydrocarbon fluid is a mix of heavier fractions of hydrocarbon fluids in a refinery, composed of bottom of atmospheric column, bottom of vacuum column, coker heavies, etc. The temperature was raised to 150° C. The asphaltenes in the feed and the asphaltenes after 1 hour residence time with the adsorbent media were analyzed per ASTM D6560 heptane insoluble method. The oil sample was mixed with heptane, agitated for 30 minutes and precipitants filtered on 0.45-micron filter paper. The weight difference of precipitated asphaltenes minus the weight of the filter paper was the asphaltene weight pickup. This was divided by the starting adsorbent media weight to determine the asphaltenes removed per unit weight of absorbent media or say weight percent picked up by the adsorbent media. This process was repeated using subsequent 80 ml batches of oil and the same adsorbent media until there was no further weight pickup. When no further weight pickup was observed, the adsorbent media was saturated. It was observed that 9.6 weight percent of asphaltenes was picked up by the adsorbent media.

A summary of the experiment is as follows:
Weight of AC+Bentonite clay extrudates: 100 grams
Samples of oil in grams in each batch: 72.87 grams
Temperature of adsorption test: 150° C.
Residence time: 1 hour
Oil processed until extrudates saturated: 2946 grams (3135 ml)
Asphaltenes pick up weight percent: 9.6%
Adsorbent's saturation capacity-grams of feed/gram of adsorbent: 29.46

### Example 6

### Activated Carbon (AC)+Magnesium Oxide (MgO)+Bentonite Clay

Activated carbon+magnesium oxide+Bentonite clay extrudates made by mixing AC powder with MgO and Bentonite clay were used for testing as the adsorbent media. The composition mixture was 40 to 60% by weight activated carbon, 20 to 40% by weight magnesium oxide, and 10 to 20% Bentonite clay. The adsorbent media was made with a lab extruder. Water and binder were used to make the AC+MgO+Bentonite clay paste for extrusion. The adsorbent media was dried. 100 grams of the adsorbent media were placed in a small, fixed bed reactor of 150 ml with 80 ml hydrocarbon fluid poured into the reactor. The hydrocarbon fluid is a mix of heavier fractions of hydrocarbon fluids in a refinery, composed of bottom of atmospheric column, bottom of vacuum column, coker heavies, etc. The temperature raised to 150° C. The asphaltenes in the feed and the asphaltenes after 1 hour residence time with the adsorbent media were analyzed per ASTM D6560 heptane insoluble method. The oil sample was mixed with heptane, agitated for 30 minutes and precipitants filtered on 0.45-micron filter paper. The weight difference of precipitated asphaltenes minus the weight of the filter paper was the asphaltene weight pickup. This was divided by the starting extrudate weight to determine the asphaltenes removed per unit weight of absorbent media or say weight percent picked up by the adsorbent media. This process was repeated using subsequent 80 ml batches of oil and the same adsorbent media until there was no further weight pickup. When no further weight pickup was observed, the adsorbent media was saturated. It was observed that 22.28 weight percent of asphaltenes was picked up by the adsorbent media.

A summary of the experiment is as follows:
Weight of AC+MgO+Bentonite clay extrudates: 100 grams
Samples of oil in grams in each batch: 72.87 grams
Temperature of adsorption test: 150° C.
Residence time: 1 hour
Oil processed until extrudates saturated: 16400 grams (18021 ml)
Asphaltenes pick up weight percent: 34.79%
Adsorbent's saturation capacity-grams of feed/gram of adsorbent: 164

### Producing Asphaltene Adsorbent Media

Activated carbon having surface area greater than 900 m²/gram derived from coconut shell, magnesium oxide made from magnesium hydroxide and bentonite clay was used to produce the adsorbent media. The invented adsorbent media was comprised of 56 grams of activated carbon, 35 grams of magnesium oxide derived from magnesium hydroxide, and 19 grams of bentonite clay. The components were combined and mixed manually. Then, about 350 ml of water with an acidic media having a 4.5 pH was added to make the dough for extrusion. Once extruded, lengths of approximately 5 to 7 mm were dried in an oven at a temperature between 300 to 600° C. It is preferable to dry at less than 500° C. to make the highly selective asphaltene adsorbent.

### Test 1

### Adsorbent Media Saturation Capacity Measurement

Adsorbent media saturation capacity was measured in a fixed bed reactor, containing 80 grams of adsorbent having the surface area >900 m²/gram, pore volume >0.45 gram/cc, pore diameter >5.5 nm, and porosity >75%. The reactor temperature was kept at 150° C., pressure at 14.7 psig, and a LHSV of 1/hr. Adsorbent media saturation capacity was defined as the amount of feed in grams per gram of adsorbent fed to the reactor to the point where >99% of the asphaltenes in the starting feed remain in the feed after adsorbent media testing. The hydrocarbon feed is a mix of heavier fractions of hydrocarbon fluids in a refinery, composed of bottom of atmospheric column, bottom of vacuum column, coker heavies, etc.

### Test 2

In another test, a vacuum gas oil hydrocarbon stream was treated at reactor temperatures of about 370° C. to about 390° C. and pressures of about 1,500 psig. The weight pick up of the asphaltene adsorbent was measured at between about 35% to about 70% using various analytical methods such as a mass balance analysis, energy-dispersive x-ray spectroscopy (EDS), and CHNS elemental analysis for carbon.

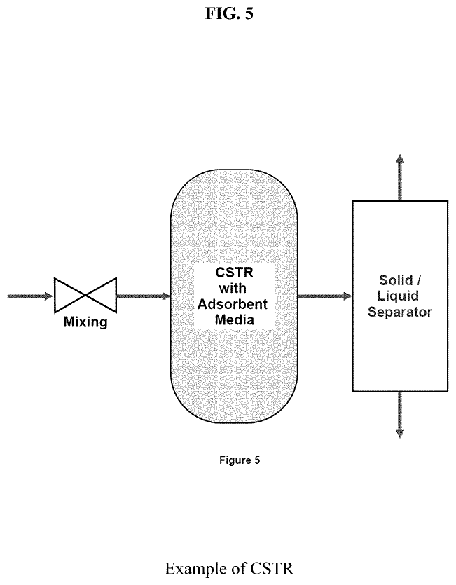

FIG. 5 is an example of a CSTR reactor. CSTR is a Continuous Stirred Type Reactor. The feed stream enters the reactor and is treated before exiting to the separator. As an illustrative embodiment, the asphaltene absorbent media may be used as a heterogeneous powder for CSTR applications. The asphaltene adsorbent media is agitated within the CSTR to promote asphaltene removal from the feed. Upon exit from the reactor, the asphaltene adsorbent powder is separated from the liquid stream and recycled back into the CSTR until the adsorbent media becomes saturated and is replaced.

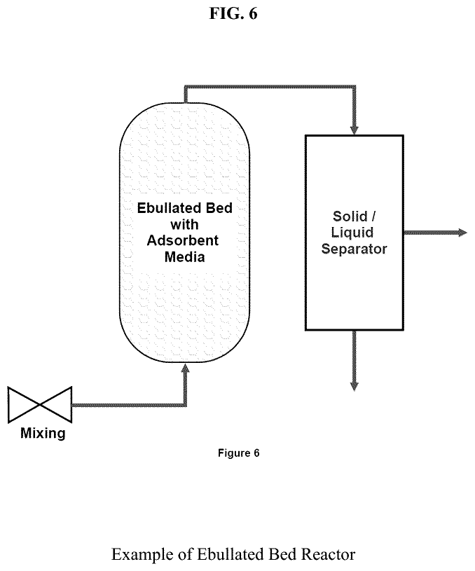

FIG. 6 is an example of an Ebullated Bed Reactor. Ebullated bed reactors are a type of fluidized bed reactor that utilizes ebullition, or bubbling, to achieve appropriate distribution of reactants and catalysts. As an illustrative embodiment, the asphaltene absorbent may be used as a heterogeneous powder or as spheres for ebullated bed applications. The fluid is processed through the asphaltene adsorbent media to promote asphaltene removal from the feed. Upon exit from the reactor, the asphaltene adsorbent powder is separated from the liquid stream and recycled back into ebullated bed until the adsorbent powder becomes saturated and is replaced. As an illustrative embodiment, 1/32″ diameter adsorbent media may be used for easy flowing and better mixing with liquid reactants.

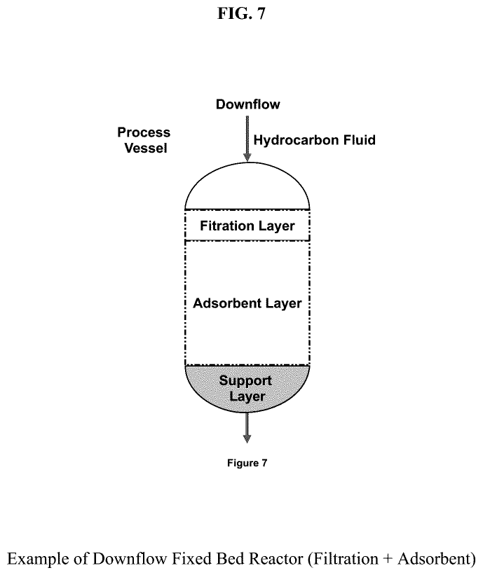

FIG. 7 is an example of a Downflow Fixed Bed Reactor (Filtration+Adsorbent). A fixed bed reactor is also known as a Plug Flow reactor. In this type of reactor, the catalyst, filtration media, poison adsorbents and supports are solids while the reactants are either liquid or vapors or mixed phase. An illustrative example of a fixed bed reactor filled with layers of filtration media and adsorbent media is shown in FIG. 7 as a pretreat to a main processing reactor. In this illustrative example, when the filtration media is full of foulants and/or the adsorbent media is saturated with the feed poisons, both the filtration media and the adsorbent media are replaced. Examples of filtration media include support balls, rings, spheres, reticulated materials, etc. In other embodiments, the layers of filtration media and adsorbent media can vary in the number of each layer, the depth of each layer and the position of each layer within the processing reactor and can include embodiments with no filtration layer and/or no support layer.

As an illustrative embodiment, the invented asphaltene adsorbent media can be used to adsorb the asphaltene molecules. The asphaltene adsorbent media can be in any shape such as pellets, tablets, rings, spheres or extrudates. Typically, the effluent from this reactor has asphaltenes less than 300 ppm or another desired limit set by the refinery.

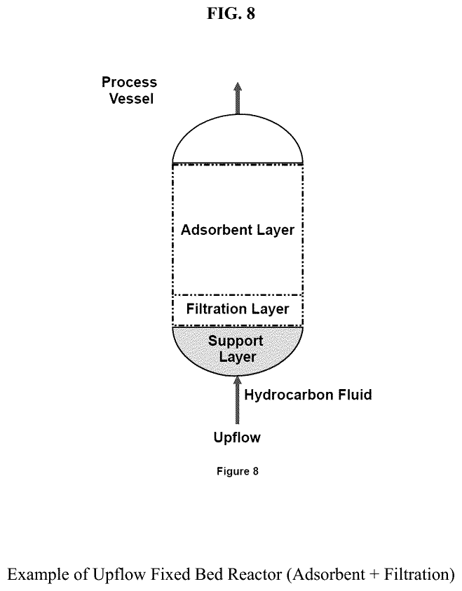

FIG. 8 is an example of an Upflow Fixed Bed Reactor (Adsorbent+Filtration). A fixed bed reactor is also known as a Plug Flow reactor. In this type of reactor, the catalyst, filtration media, poison adsorbents and supports are solids while the reactants are either liquid or vapors or mixed phase. An illustrative example of a fixed bed reactor filled with layers of filtration media and adsorbent media is shown in FIG. 8 as a pretreat to a main processing reactor. In this illustrative example, when the filtration media is full of foulants and/or the adsorbent media is saturated with the feed poisons, both the filtration media and the adsorbent media are replaced. Examples of filtration media include support balls, pellets, tablets, rings, spheres, reticulated materials, etc. In other embodiments, the layers of filtration media and adsorbent media can vary in the number of each layer, the depth of each layer and the position of each layer within the processing reactor and can include embodiments with no filtration layer and/or no support layer.

As an illustrative embodiment, the invented asphaltene adsorbent media can be used to adsorb the asphaltene molecules. The adsorbent media is installed on top of the filtration media as shown in FIG. 8 for an upflow reactor. The asphaltene adsorbent media can be in any shape such as pellets, tablets, rings, spheres or extrudates. Typically, the effluent from this reactor has asphaltenes less than 300 ppm or another desired limit set by the refinery.

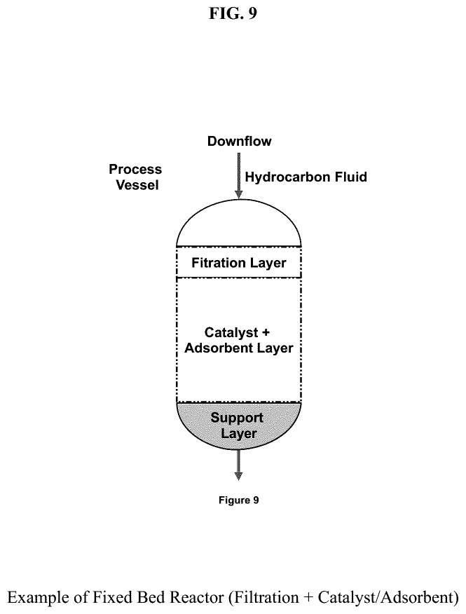

FIG. 9 is an example of a Fixed Bed Reactor (Filtration+Catalyst/Adsorbent). A fixed bed reactor is also known as Plug Flow reactor. In this type of reactor, the catalyst, filtration media, poison adsorbents and supports are solids while the reactants are either liquid or vapors or mixed phase. An illustrative example of a fixed bed reactor filled with layers of filtration media and a catalyst/adsorbent media is shown in FIG. 9 as a filtration and processing reactor. In this illustrative example, when the filtration media is full of foulants and/or the catalyst/adsorbent media is saturated with the feed poisons, both the filtration media and the catalyst/adsorbent media are replaced. Examples of filtration media include support balls, pellets, tablets, rings, spheres, reticulated materials, etc. In other embodiments, the layers of filtration media and catalyst/adsorbent media can vary in the number of each layer, the depth of each layer and the position of each layer within the processing reactor and can include embodiments with no filtration layer and/or no support layer.

As an illustrative embodiment, the invented asphaltene adsorbent media can be intermingled within the catalyst media to adsorb the asphaltene molecules. The asphaltene adsorbent media can be in any shape such as pellets, tablets, rings, spheres or extrudates. Typically, the effluent from this reactor has asphaltenes less than 300 ppm or another desired limit set by the refinery.

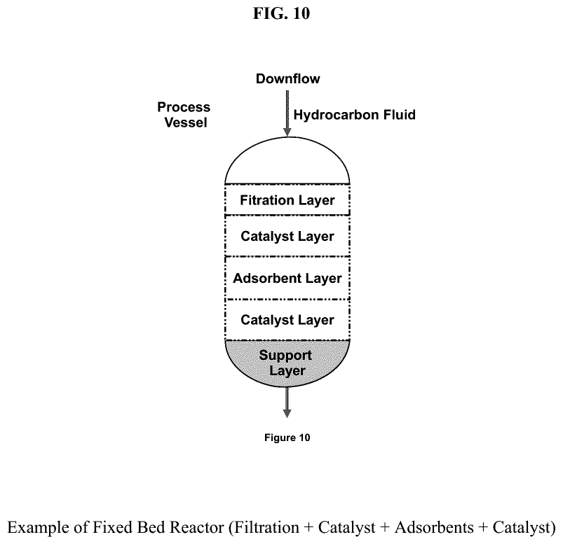

FIG. 10 is an example of a Fixed Bed Reactor (Filtration+Catalyst+Adsorbents+Catalyst). A fixed bed reactor is also known as a Plug Flow reactor. In this type of reactor, the catalyst, filtration media, poison adsorbents and supports are solids while the reactants are either liquid or vapors or mixed phase. An illustrative example of a fixed bed reactor filled with layers of filtration media, catalyst media, adsorbent media and catalyst media is shown in FIG. 10 as a filtration and processing reactor. In this illustrative example, the adsorbent media can be installed in any layer between the filtration media layer and the support media layer. In this illustrative example, when the filtration media is full of foulants and/or the catalyst media and/or adsorbent media is saturated with the feed poisons, the filtration media, the catalyst media and the adsorbent media are replaced. Examples of filtration media could be either support balls, pellets, tablets, rings, spheres, reticulated materials, etc. In other embodiments, the layers of filtration media, catalyst media and adsorbent media can vary in the number of each layer, the depth of each layer and the position of each layer within the processing reactor and can include embodiments with no filtration layer and/or no support layer.

As an illustrative embodiment, the invented asphaltene adsorbent media can be layered within the catalyst media to adsorb the asphaltene molecules. The asphaltene adsorbent media can be in any shape such as pellets, tablets, rings, spheres or extrudates. Typically, the effluent from this reactor has asphaltenes less than 300 ppm or another desired limit set by the refinery.

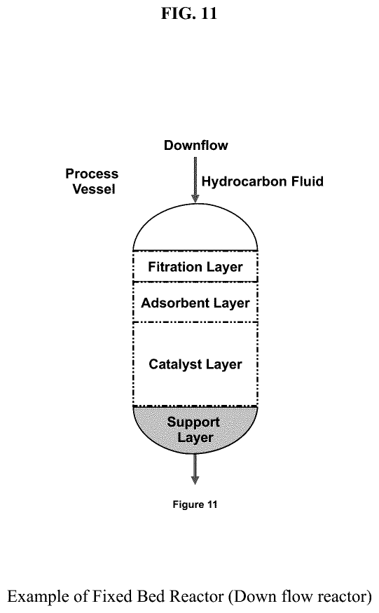

FIG. 11 is an example of a Fixed Bed Reactor (Down flow reactor). A fixed bed reactor is also known as a Plug Flow reactor. In this type of reactor, the catalyst, filtration media, poison adsorbents and supports are solids while the reactants are either liquid or vapors or mixed phase. An illustrative example of a fixed bed reactor filled with layers of filtration media, adsorbent media and catalyst media is shown in FIG. 11 as a filtration and processing reactor. In this illustrative example, the adsorbent media can be installed in any layer between the filtration media layer and the support media layer. The layers of catalyst media and adsorbent media can vary in depth and position within the processing reactor. In this illustrative example, when the filtration media is full of foulants and/or the catalyst media and/or adsorbent media is saturated with the feed poisons, the filtration media, the catalyst media and the adsorbent media are replaced. Examples of filtration media could be either support balls, pellets, tablets, rings, spheres, reticulated materials, etc.

As an illustrative embodiment, the invented asphaltene adsorbent media can be layered below the filtration media layer to adsorb the asphaltene molecules. In this illustrative embodiment, the adsorbent media is installed above the catalyst media and beneath the filtration media as shown in FIG. 11 for a downflow reactor. The asphaltene adsorbent media can be in any shape such as pellets, tablets, rings, spheres or extrudates. Typically, the effluent from this reactor has asphaltenes less than 300 ppm or another desired limit set by the refinery.

In accordance with the presently disclosed subject matter, various illustrative embodiments of an asphaltene adsorbent media, its method of preparation and a method of removing asphaltenes from hydrocarbon streams are provided herein.

In certain illustrative embodiments, a method of removing soluble asphaltene compounds from a hydrocarbon fluid within a process vessel is provided. The hydrocarbon fluid can be passed over at least one layer of solid adsorbent media in the process vessel, wherein the solid adsorbent media is a multi-component media comprising at least one metal oxide, at least one clay, and at least one activated carbon. At least some of the soluble asphaltene compounds of the hydrocarbon fluid can be adsorbed on the solid adsorbent media. The process vessel can have at least one fixed bed therein. The solid adsorbent media can include at least one of extrudates, pellets, tablets, rings, reticulated materials and monoliths. The solid adsorbent media can include at least one of rings, trilobes, quad lobes and polyhedrons. The metal oxide, the clay and the activated carbon are not used as a support material for the at least one metal oxide.

In certain illustrative embodiments, a method of removing asphaltene from a hydrocarbon fluid containing soluble asphaltene compounds within a process vessel is provided. A solid adsorbent media can be mixed into the hydrocarbon fluid, wherein the solid adsorbent media is a multi-component media comprising at least one metal oxide, at least one clay, and at least one activated carbon. The hydrocarbon fluid containing the solid adsorbent media can be introduced into the process vessel. The hydrocarbon fluid containing the solid adsorbent media can be passed through the process vessel over a period of time. The hydrocarbon fluid containing the solid adsorbent media can then be removed from the process vessel, wherein upon removal the asphaltene content of the hydrocarbon fluid is less than when the hydrocarbon fluid was introduced into the process vessel. Additionally, the hydrocarbon fluid can be introduced into a liquid-solid separation process after the hydrocarbon fluid is removed from the process vessel. The solid adsorbent media can include at least one of extrudates, pellets, tablets, rings, reticulated materials and monoliths. The solid adsorbent media can include at least one of rings, trilobes, quad lobes and polyhedrons.

In certain illustrative embodiments, a method of generating a multi-component asphaltene adsorbent media is provided. A first powder comprising an activated carbon, a second powder comprising a metal oxide, and a third powder comprising a clay can be mixed to form a powder mixture. The powder mixture can be introduced into an aqueous acidic solution to generate a dough. Water can be removed from the dough to produce an adsorbent-base. The adsorbent-base can be calcined to produce a calcined-adsorbent-base. The calcined-adsorbent-base can be ground to produce an adsorbent powder. Additionally, the adsorbent powder can be formed or shaped into one or more of extrudates, pellets, tablets, rings, reticulated materials and monoliths. The adsorbent powder can be formed or shaped into one or more of rings, trilobes, quad lobes and polyhedrons.

In certain illustrative embodiments, a method of generating a multi-component asphaltene adsorbent media is provided. A first powder comprising an activated carbon, a second powder comprising a metal oxide, and a third powder comprising a clay can be mixed to form a powder mixture. The powder mixture can be introduced into an aqueous acidic solution to generate a dough. The dough can be shaped to produce a shaped-adsorbent media. Water can be removed from the shaped-adsorbent media to produce a dried-shaped-adsorbent media. The dried-shaped-adsorbent media can be calcined to produce a shaped-calcined-adsorbent media. Additionally, the shaped-calcined-adsorbent media can include one or more of extrudates, pellets, tablets, rings, reticulated materials and monoliths. The shaped-calcined-adsorbent media comprises one or more of rings, trilobes, quad lobes and polyhedrons.

In certain illustrative embodiments, a method of removing asphaltene from a hydrocarbon fluid containing soluble asphaltene compounds within a pre-treatment vessel is provided. The hydrocarbon fluid can be introduced into the pre-treatment vessel, wherein the pre-treatment vessel is located upstream of a process vessel. The hydrocarbon fluid can be passed over at least one layer of solid adsorbent media in the pre-treatment vessel, wherein the solid adsorbent media is a multi-component media comprising at least one metal oxide, at least one clay, and at least one activated carbon, and wherein having passed through the at least one layer of solid adsorbent media, the asphaltene content in the hydrocarbon fluid is reduced. In some aspects, the reduction can by at least 10 weight percent less (preferably 20 weight percent less, preferably 40 weight percent less, preferably 50 weight percent less, preferably 60 weight percent less, preferably 75 weight percent less, preferably 80 weight percent less, preferably 90 weight percent less, preferably 99 weight percent less) of the asphaltenes as compared to the hydrocarbon stream. The pre-treatment vessel can have at least one fixed bed therein. Additionally, the shaped-calcined-adsorbent media can include one or more of extrudates, pellets, tablets, rings, reticulated materials and monoliths. The shaped-calcined-adsorbent media comprises one or more of rings, trilobes, quad lobes and polyhedrons.

In certain illustrative embodiments, a method of removing soluble asphaltene compounds from a hydrocarbon fluid within a pre-treatment vessel is provided. The hydrocarbon fluid can be passed over at least one layer of solid adsorbent media in the pre-treatment vessel, wherein the solid adsorbent media is a multi-component media comprising at least one metal oxide, at least one clay, and at least one activated carbon, and wherein the pre-treatment vessel located upstream of a process vessel. At least 10 weight percent less (preferably 20 weight percent less, preferably 40 weight percent less, preferably 50 weight percent less, preferably 60 weight percent less, preferably 75 weight percent less, preferably 80 weight percent less, preferably 90 weight percent less, preferably 99 weight percent less) of the soluble asphaltene compounds within the hydrocarbon fluid can be adsorbed on the solid adsorbent media. The pre-treatment vessel can have at least one fixed bed therein. The solid adsorbent media can include one or more of extrudates, pellets, tablets, rings, reticulated materials and monoliths. The solid adsorbent media can include one or more of rings, trilobes, quad lobes and polyhedrons. The solid adsorbent media can adsorb the asphaltene content when the temperature of the hydrocarbon fluid is below 200° C. and above 20° C.

In certain illustrative embodiments, a method of removing soluble asphaltene compounds from a hydrocarbon fluid within a process vessel is provided. The hydrocarbon fluid can be passed over at least one layer of solid adsorbent media in the process vessel, wherein the solid adsorbent media is a multi-component media comprising magnesium oxide, at least one clay, and at least one activated carbon. At least some of the soluble asphaltene compounds within the hydrocarbon fluid can be adsorbed on the solid adsorbent media. In some aspects, the adsorption can be least 10 weight percent less (preferably 20 weight percent less, preferably 40 weight percent less, preferably 50 weight percent less, preferably 60 weight percent less, preferably 75 weight percent less, preferably 80 weight percent less, preferably 90 weight percent less, preferably 99 weight percent less) of the soluble asphaltene compounds within the hydrocarbon fluid.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter.

Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the claims herein.

What is claimed is:

1. A method of removing soluble asphaltene compounds from a hydrocarbon fluid within a process vessel, comprising:
passing the hydrocarbon fluid over at least one layer of solid adsorbent media in the process vessel, wherein the solid adsorbent media is a multi-component media comprising at least one metal oxide, at least one clay, and at least one activated carbon; and
adsorbing at least some of the soluble asphaltene compounds of the hydrocarbon fluid on the solid adsorbent media.

2. The method of claim 1, wherein the process vessel has at least one fixed bed therein.

3. The method of claim 1, where the solid adsorbent media comprises at least one of extrudates, pellets, tablets, rings, reticulated materials, and monoliths.

4. The method of claim 1, where the solid adsorbent media comprises at least one of rings, trilobes, quad lobes and polyhedrons.

5. The method of claim 1, wherein the metal oxide, the clay and the activated carbon are not used as a support material for the at least one metal oxide.

6. The method of claim 1, wherein the amount of soluble asphaltene compounds in the hydrocarbon fluid is reduced by at least 10 weight percent.

7. A method of removing asphaltene from a hydrocarbon fluid containing soluble asphaltene compounds within a process vessel, comprising:
mixing a solid adsorbent media into the hydrocarbon fluid, wherein the solid adsorbent media is a multi-component media comprising at least one metal oxide, at least one clay, and at least one activated carbon;
introducing the hydrocarbon fluid containing the solid adsorbent media into the process vessel;
passing the hydrocarbon fluid containing the solid adsorbent media through the process vessel; and
removing the hydrocarbon fluid containing the solid adsorbent media from the process vessel, wherein upon removal the asphaltene content of the hydrocarbon fluid is less than when the hydrocarbon fluid was introduced into the process vessel.

8. The method of claim 7, further comprising introducing the hydrocarbon fluid into a liquid-solid separation process after the hydrocarbon fluid is removed from the process vessel.

9. The method of claim 7, where the solid adsorbent media comprises at least one of extrudates, pellets, tablets, rings, reticulated materials and monoliths.

10. The method of claim 7, where the solid adsorbent media comprises at least one of rings, trilobes, quad lobes and polyhedrons.

11. The method of claim 7, where the amount of soluble asphaltene compounds in the hydrocarbon fluid is less than when the hydrocarbon fluid is introduced into the process vessel by at least 10 weight percent.

12. A method of generating a multi-component asphaltene adsorbent media, comprising:
mixing a first powder comprising an activated carbon, a second powder comprising a metal oxide, and a third powder comprising a clay to form a powder mixture;
introducing the powder mixture into an aqueous acidic solution to generate a dough;
removing water from the dough to produce an adsorbent-base;
calcining the adsorbent-base to produce a calcined-adsorbent-base; and
grinding the calcined-adsorbent-base to produce an adsorbent powder.

13. The method of claim 12, further comprising forming the adsorbent powder into one or more of extrudates, pellets, tablets, rings, reticulated materials and monoliths.

14. The method of claim 12, further comprising forming the adsorbent powder into one or more of rings, trilobes, quad lobes and polyhedrons.

15. A method of generating a multi-component asphaltene adsorbent media, comprising:
mixing a first powder comprising an activated carbon, a second powder comprising a metal oxide, and a third powder comprising a clay to form a powder mixture;
introducing the powder mixture into an aqueous acidic solution to generate a dough;
shaping the dough to produce a shaped-adsorbent media;
removing water from the shaped-adsorbent media to produce a dried-shaped-adsorbent media; and
calcining the dried-shaped-adsorbent media to produce a shaped-calcined-adsorbent media.

16. The method of claim 15, where the shaped-calcined-adsorbent media comprises one or more of extrudates, pellets, tablets, rings, reticulated materials and monoliths.

17. The method of claim 15, where the shaped-calcined-adsorbent media comprises one or more of rings, trilobes, quad lobes and polyhedrons.

18. A method of removing asphaltene from a hydrocarbon fluid containing soluble asphaltene compounds within a pre-treatment vessel, comprising:
introducing the hydrocarbon fluid into the pre-treatment vessel, wherein the pre-treatment vessel is located upstream of a process vessel; and
passing the hydrocarbon fluid over at least one layer of solid adsorbent media in the pre-treatment vessel,
wherein the solid adsorbent media is a multi-component media comprising at least one metal oxide, at least one clay, and at least one activated carbon,
and wherein having passed through the at least one layer of solid adsorbent media, the asphaltene content in the hydrocarbon fluid is reduced.

19. The method of claim 18, wherein the pre-treatment vessel has at least one fixed bed therein.

20. The method of claim 18, wherein the amount of soluble asphaltene compounds in the hydrocarbon fluid is reduced by at least 10 weight percent.

21. A method of removing soluble asphaltene compounds from a hydrocarbon fluid within a pre-treatment vessel, comprising:
passing the hydrocarbon fluid over at least one layer of solid adsorbent media in the pre-treatment vessel, wherein the solid adsorbent media is a multi-component media comprising at least one metal oxide, at least one clay, and at least one activated carbon, and wherein the pre-treatment vessel located upstream of a process vessel; and
adsorbing at least some of the soluble asphaltene compounds hydrocarbon fluid on the solid adsorbent media.

22. The method of claim 21, wherein the pre-treatment vessel has at least one fixed bed therein.

23. The method of claim 21, where the solid adsorbent media comprises one or more of extrudates, pellets, tablets, rings, reticulated materials and monoliths.

24. The method of claim 21, where the solid adsorbent media comprises one or more of rings, trilobes, quad lobes and polyhedrons.

25. The method of claim 21, where the solid adsorbent media adsorbs the asphaltene content when the temperature of the hydrocarbon fluid is below 200° C. and above 20° C.

26. The method of claim 21, wherein the amount of soluble asphaltene compounds in the hydrocarbon fluid is reduced by at least 10 weight percent.

27. A method of removing soluble asphaltene compounds from a hydrocarbon fluid within a process vessel, comprising:
passing the hydrocarbon fluid over at least one layer of solid adsorbent media in the process vessel, wherein the solid adsorbent media is a multi-component media comprising magnesium oxide, at least one clay, and at least one activated carbon; and
adsorbing at least some of the soluble asphaltene compounds of the hydrocarbon fluid on the solid adsorbent media.

28. The method of claim 27, wherein the soluble asphaltene compounds content is reduced and the solid adsorbent media weight pickup is at least 10%.
